(19) United States
(12) Patent Application Publication
(10) Pub. No.: US 2026/0181579 A1
(43) Pub. Date: Jun. 25, 2026

(54) METHOD AND APPARATUS FOR POSITIONING IN WIRELESS COMMUNICATION SYSTEM

(71) Applicant: SAMSUNG ELECTRONICS CO., LTD., Suwon-si, Gyeonggi-do (KR)

(72) Inventors: Xingyu HAN, Beijing (CN); Weiwei WANG, Beijing (CN); Hong WANG, Beijing (CN)

(21) Appl. No.: 18/998,103

(22) PCT Filed: Jul. 10, 2023
(86) PCT No.: PCT/KR2023/009716

§ 371 Date: Jan. 23, 2025

(30) Foreign Application Priority Data
Jul. 25, 2022 (CN) 202210880667.X

(51) Int. Cl. H04W 64/00; H04W 92/18

(52) U.S. Cl. CPC H04W 64/00; H04W 92/18

(57) ABSTRACT

The disclosure relates to a 5G or 6G communication system for supporting a higher data transmission rate. A method performed by a first node in a wireless communication system is provided. The method comprises receiving information related to one or more user equipments (UEs), based on information related to at least one UE of the one or more UEs among the information related to the one or more UEs, transmitting, to a second node, a first request message for requesting the third node to configure a sidelink positioning reference signal (SL-PRS), receiving, from the second node, a first response message as a response of the first request message, the first response message including configuration information for the SL-PRS and transmitting the configuration information for the SL-PRS.

### TECHNICAL FIELD

The disclosure generally relates to wireless communication systems, and in particular, to a method and an apparatus for positioning in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

A method performed by a first node in a wireless communication system is provided. The method comprises receiving information related to one or more user equipments (UEs), based on information related to at least one UE of the one or more UEs among the information related to the one or more UEs, transmitting, to a second node, a first request message for requesting the third node to configure a sidelink positioning reference signal (SL-PRS), receiving, from the second node, a first response message as a response of the first request message, the first response message including configuration information for the SL-PRS and transmitting the configuration information for the SL-PRS.

A first node in a wireless communication system is provided. The first node comprises a transceiver and a controller coupled with the transceiver and configured to receive information related to one or more user equipments (UEs), based on information related to at least one UE of the one or more UEs among the information related to the one or more UEs, transmit, to a second node, a first request message for requesting the third node to configure a sidelink positioning reference signal (SL-PRS), receive, from the second node, a first response message as a response of the first request message, the first response message including configuration information for the SL-PRS and transmit the configuration information for the SL-PRS.

A method performed by a second node in a wireless communication system is provided. The method comprises transmitting, to first node, information related to one or more user equipments (UEs), receiving, from the first node, a first request message for requesting configuring a sidelink positioning reference signal (SL-PRS), transmitting, to the first node, a first response message as a response of the first request message, the first response message including configuration information for the SLPRS.

A second node in a wireless communication system is provided. The second node comprises a transceiver and a controller coupled with the transceiver and configured to transmit, to first node, information related to one or more user equipments (UEs), receive, from the first node, a first request message for requesting configuring a sidelink positioning reference signal (SL-PRS), and transmit, to the first node, a first response message as a response of the first request message, the first response message including configuration information for the SL-PRS.

### BRIEF DESCRIPTION OF DRAWINGS

The above and other aspects, features, and advantages of the present disclosure will be more apparent from the following detailed description when taken in conjunction with the accompanying drawings, in which:

FIG. 1 is an exemplary system architecture of System Architecture Evolution (SAE);

FIG. 2 is an exemplary system architecture according to an embodiment;

FIG. 3 illustrates a schematic diagram of the configuration of a distributed unit and a central unit of a base station according to an embodiment;

FIG. 4A illustrates a schematic diagram of a method of anchor UE capability transfer according to an embodiment;

FIG. 4B illustrates a schematic diagram of a method of anchor UE capability transfer according to an embodiment;

FIG. 4C illustrates a schematic diagram of a method of anchor UE capability transfer according to an embodiment;

FIG. 5A illustrates a schematic diagram of a configuration method of a sidelink reference signal according to an embodiment;

FIG. 5B illustrates a schematic diagram of a configuration method of a sidelink reference signal according to an embodiment;

FIG. 5C illustrates a schematic diagram of a configuration method of a sidelink reference signal according to an embodiment;

FIG. 6A illustrates a schematic diagram of a method for activation and/or deactivation of a sidelink positioning reference signal according to an embodiment;

FIG. 6B illustrates a schematic diagram of a method for activation and/or deactivation of a sidelink positioning reference signal according to an embodiment;

FIG. 6C illustrates a schematic diagram of a method for activation and/or deactivation of a sidelink positioning reference signal according to an embodiment;

FIG. 6D illustrates a schematic diagram of a method for activation and/or deactivation of a sidelink positioning reference signal according to an embodiment;

FIG. 7 illustrates a schematic diagram of a method for identifying an anchor UE according to an embodiment;

FIG. 8A illustrates a schematic diagram of an operation method considering UE mobility according to an embodiment;

FIG. 8B illustrates a schematic diagram of an operation method considering UE mobility according to an embodiment;

FIG. 9 illustrates a schematic diagram of a method of an anchor UE status updating/modification according to an embodiment;

FIG. 10 illustrates a block diagram of a configuration of a node according to an embodiment;

FIG. 11 illustrates a structure of a UE according to an embodiment of the disclosure; and

FIG. 12 illustrates a structure of a base station according to an embodiment of the disclosure.

### BEST MODE FOR CARRYING OUT THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies.

In the description of the disclosure, when it is considered that some detailed explanations about functions or configurations may unnecessarily obscure the essence of the disclosure, these detailed explanations will be omitted. All terms (including descriptive or technical terms) used herein should be interpreted as having apparent meanings to those of ordinary skill in the art. However, these terms may have different meanings according to the intention of those of ordinary skill in the art, precedents or the emergence of new technologies, and therefore, the terms used herein must be defined based on the meanings of these terms together with the description throughout the specification. Hereinafter, for example, the base station (BS) may be at least one of a gNode B, an eNode B, a Node B, a radio access unit, a base station controller, and a node on a network. The terminal may include a user equipment (UE), a mobile station (MS), a mobile phone, a smart phone, a computer or multimedia system capable of performing communication functions. In some embodiments of the disclosure, the downlink (DL) may be a wireless transmission path through which signals are transmitted from a base station to a terminal, and the uplink (UL) may be a wireless transmission path through which signals are transmitted from a terminal to a base station.

Hereinafter, the embodiments of the disclosure will be described in detail with reference to the accompanying drawings. It should be noted that the same reference numerals in different drawings will be used to refer to the same elements already described.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication n, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Wireless communication is one of the most successful innovations in modern history. Recently, the number of subscribers of wireless communication services has exceeded 5 billion, and it continues to grow rapidly. Due to the increasing popularity of smart phones and other mobile data devices (such as tablet computers, notebook computers, netbooks, e-book readers and machine-type devices) among consumers and enterprises, the demand for wireless data services is growing rapidly. In order to meet the rapid growth of mobile data services and support new applications and deployments, it is very important to improve the efficiency and coverage of wireless interfaces.

With the maturity of 5G commercial network (for example, NR (New Radio) access network), the application scope of the NR positioning technology is also expanding. In order to better meet the positioning requirements of scenes or applications such as vehicle to everything (V2X) and industrial Internet of Things (IIOT), the research and standardization of positioning methods (for example, Sidelink Positioning) for direct communication between things have also been launched.

According to at least one embodiment of the disclosure, there is provided a method performed by a first node in a wireless communication system. The method includes: obtaining information related to one or more user equipments (UEs); transmitting the information related to the one or more UEs; and receiving configuration information for a sidelink positioning reference signal (SL-PRS or S-PRS).

In some implementations, for example, the information related to the one or more UEs is transmitted by the first node to a second node, and the configuration information for the sidelink positioning reference signal (SL-PRS) is received by the first node from a third node. Based on information related to at least one of the one or more UEs among the received information related to the one or more UEs, a first request message for requesting the third node to configure the sidelink positioning reference signal (SL-PRS) is transmitted by the second node to the third node, and a first response message including the configuration information for the sidelink positioning reference signal is received by the second node from the third node in response to the first request message.

In some implementations, for example, the first request message includes at least one of: a UE identity (ID); or requested sidelink positioning reference signal transmission characteristics.

In some implementations, for example, the UE ID includes at least one of:
a NG Application Protocol (NGAP) ID;
a Proximity-based service (ProSe) application code or ProSe application code prefix;
a ProSe restricted code or ProSe restricted code prefix;
a ProSe response code or ProSe query code;
a source or destination layer-2 ID;
a source or destination layer-2 ID for direct discovery;
a source or destination layer-2 ID for direct discovery;
a source or destination layer-2 ID for relay discovery;
a source or destination layer-2 ID for relay communication;
a relay service code;
a new ProSe identity; or
a new sidelink positioning identity.

In some implementations, for example, the UE ID corresponds to a UE of the one or more UEs.

In some implementations, for example, the requested sidelink positioning reference signal transmission characteristics includes at least one of:
a start frequency point of the sidelink positioning reference signal;
a bandwidth of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a resource number of symbols of the sidelink positioning reference signal;
a starting time of transmission of the sidelink positioning reference signal; or
a duration of the transmission of the sidelink positioning reference signal.

In some implementations, for example, the information related to the one or more UEs is transmitted by the first node to the third node. The configuration information for the sidelink positioning reference signal is received by the first node from the third node and generated by the third node based on the information related to at least one of the one or more UEs among the received information related to the one or more UEs.

In some implementations, for example, the configuration information for the sidelink positioning reference signal is generated by a distributed unit of the third node in response to a request of a central unit of the third node.

In some implementations, for example, the configuration information for the sidelink positioning reference signal received by the first node includes at least one of:
a subcarrier spacing of the sidelink positioning reference signal;
a start frequency point of the sidelink positioning reference signal;
a bandwidth of the sidelink positioning reference signal;
a number of physical resource blocks (PRBs) occupied by the resource of the sidelink positioning reference signal;
an offset of an available resource of the sidelink positioning reference signal relative to the start frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

In some implementations, for example, the method further includes receiving a message for activating or deactivating transmission of one or at least one of the one or more sidelink positioning reference signals.

In some implementations, for example, in response to a second request message transmitted by the second node for requesting activation or deactivation of transmission of one or at least one of the one or more sidelink positioning reference signals, a second response message for activating or deactivating the transmission of the one or the at least one of the one or more sidelink positioning reference signals is generated by the third node. The message for activating or deactivating the transmission of one or at least one of the one or more sidelink positioning reference signals is received by the first node from the third node.

In some implementations, for example, the message for activating or deactivating the transmission of the one or the at least one of the one or more sidelink positioning reference signals is generated by the distributed unit of the third node in response to a request of a central unit of the third node.

In some implementations, for example, the message for activating or deactivating the transmission of the one or the at least one of the one or more sidelink positioning reference signals is received by the first node from the second node.

In some implementations, for example, in response to a third request message transmitted by the third node for requesting at least one UE ID, a third response message is transmitted by the fourth node to the third node, wherein the third response message includes the at least one UE ID. The at least one UE ID corresponds to at least one of the one or more UEs.

In some implementations, for example, each of the at least one UE ID includes at least one of:
a NGAP ID;
a ProSe application code or ProSe application code prefix;
a ProSe restricted code or ProSe restricted code prefix;
a ProSe response code or ProSe query code;
a source or destination layer-2 ID;
a source or destination layer-2 ID for direct discovery;
a source or destination layer-2 ID for direct discovery;
a source or destination layer-2 ID for relay discovery;
a source or destination layer-2 ID for relay communication;
a relay service code;
a new ProSe identity; or
a new sidelink positioning identity.

In some implementations, for example, the obtaining of the information related to one or more UEs includes receiving, from a fifth node, the information related to the one or more UEs.

In some implementations, for example, the method further includes: receiving, from the second node, a fourth request message for requesting for report of information related to the sidelink positioning; and in response to the fourth request message, transmitting, to the second node, a fourth response message including the information related to the sidelink positioning.

In some implementations, for example, the information related to the sidelink positioning includes at least one of: information indicating supported sidelink positioning methods; or information indicating whether the second node can be used as an anchor UE.

In some implementations, for example, the method further includes receiving a positioning reference signal from the fifth node based on the configuration information for the sidelink positioning reference signal, or transmitting a positioning reference signal to the fifth node based on the configuration information for the sidelink positioning reference signal.

In some implementations, for example, the first node is a UE. For example, the UE may be a UE that has a positioning requirement/that is positioned/that performs sidelink positioning.

In some implementations, for example, the second node is a Location Management Function (LMF).

In some implementations, for example, the third node is a base station.

In some implementations, for example, the fourth node is an Access and Mobility Management Function (AMF).

In some implementations, for example, the fifth node is another UE. For example, the other UE may be a UE for supporting or assisting or participating in the sidelink positioning of the first node.

According to at least one embodiment of the disclosure, there is provided a method performed by a second node in a wireless communication system. The method includes: receiving information related to one or more UEs; based on information related to at least one of the one or more UEs among the information related to the one or more UEs, transmitting a first request message to a third node for requesting the third node to configure a sidelink positioning reference signal; in response to the first request message, receiving a first response message from a third node, wherein the first response message includes configuration information for the sidelink positioning reference signal; and transmitting the configuration information for the sidelink positioning reference signal.

In some implementations, for example, the information related to the one or more UEs includes at least UE identities (IDs) of the one or more UEs.

In some implementations, for example, the UE ID includes at least one of:
a NGAP ID;
a ProSe application code or ProSe application code prefix;
a ProSe restricted code or ProSe restricted code prefix;
a ProSe response code or ProSe query code;
a source or destination layer-2 ID;
a source or destination layer-2 ID for direct discovery;
a source or destination layer-2 ID for direct discovery;
a source or destination layer-2 ID for relay discovery;
a source or destination layer-2 ID for relay communication;
a relay service code;
a new ProSe identity; or
a new sidelink positioning identity.

In some implementations, for example, the first request message includes at least one of: a UE ID; or requested sidelink positioning reference signal transmission characteristics.

In some implementations, for example, the UE ID included in the first request message includes at least one of:
a NG Application Protocol (NGAP) ID;
a Proximity-based service (ProSe) application code or ProSe application code prefix;
a ProSe restricted code or ProSe restricted code prefix;
a ProSe response code or ProSe query code;
a source or destination layer-2 ID;
a source or destination layer-2 ID for direct discovery;
a source or destination layer-2 ID for direct discovery;
a source or destination layer-2 ID for relay discovery;
a source or destination layer-2 ID for relay communication;
a relay service code;
a new ProSe identity; or
a new sidelink positioning identity.

In some implementations, for example, the UE ID included in the first request message corresponds to a UE of the one or more UEs.

In some implementations, for example, the requested sidelink positioning reference signal transmission characteristics includes at least one of:
a start frequency point of the sidelink positioning reference signal;
a bandwidth of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a resource number of symbols of the sidelink positioning reference signal;
a starting time of transmission of the sidelink positioning reference signal; or
a duration of the transmission of the sidelink positioning reference signal.

In some implementations, for example, the method further includes: transmitting a second request message to the third node for requesting activation or deactivation of transmission of one or at least one of the one or more sidelink positioning reference signals; and in response to the second request message, receiving a second response message from the third node, wherein the second response message is used for activating or deactivating the transmission of the one or the at least one of the one or more sidelink positioning reference signals.

In some implementations, for example, the method further includes: transmitting, to the first node, a message for activating or deactivating the transmission of one or at least one of the one or more sidelink positioning reference signals.

In some implementations, for example, a third request message for requesting at least one UE ID is transmitted to a fourth node, wherein the at least one UE ID corresponds to at least one of the one or more UEs; and in response to the third request message, a third response message is received from the fourth node, wherein the third response message includes the at least one UE ID.

In some implementations, for example, each of the at least one UE ID includes at least one of:
a NGAP ID;
a ProSe application code or ProSe application code prefix;
a ProSe restricted code or ProSe restricted code prefix;
a ProSe response code or ProSe query code;
a source or destination layer-2 ID;
a source or destination layer-2 ID for direct discovery;
a source or destination layer-2 ID for direct discovery;
a source or destination layer-2 ID for relay discovery;
a source or destination layer-2 ID for relay communication;
a relay service code;
a new ProSe identity; or
a new sidelink positioning identity.

In some implementations, for example, the method further includes: receiving, from the third node, information indicating a status of the fifth node and/or information for releasing one or at least one of the one or more configured sidelink positioning reference signals; or receiving information, from the fifth node, indicating a status of the fifth node.

In some implementations, for example, the method further includes: transmitting, to the first node, information indicating a status of the fifth node.

In some implementations, for example, the method further includes: transmitting, to the first node or the fifth node, a fourth request message for requesting for report of information related to the sidelink positioning; in response to the fourth request message, receiving a fourth response message from the first node or the fifth node, wherein the fourth response message includes the information related to the sidelink positioning.

In some implementations, for example, the information related to the sidelink positioning includes at least one of: information indicating supported sidelink positioning methods; or information indicating whether the first node or the fifth node can be used as an anchor UE; or identification information of the fifth node.

In some implementations, for example, the method further includes: receiving, from the third node, updated configuration information for the sidelink positioning reference signal.

In some implementations, for example, the information related to the one or more UEs is received from at least one of the first node, the third node or the fifth node.

In some implementations, for example, the configuration information for the sidelink positioning reference signal is transmitted to at least one of the first node, the third node or the fifth node.

In some implementations, for example, the positioning reference signal is received from the fifth node by the first node based on the configuration information for the sidelink positioning reference signal, or the positioning reference signal is transmitted to the fifth node by the first node based on the configuration information for the sidelink positioning reference signal.

In some implementations, for example, the first node is a UE. For example, the UE may be a UE that has a positioning requirement/that is positioned/that performs sidelink positioning.

In some implementations, for example, the second node is a Location Management Function (LMF).

In some implementations, for example, the third node is a base station.

In some implementations, for example, the fourth node is an Access and Mobility Management Function (AMF).

In some implementations, for example, the fifth node is another UE. For example, another UE may be a UE for supporting or assisting or participating in the sidelink positioning of the first node.

According to at least one embodiment of the disclosure, there is provided a method performed by a third node in a wireless communication system. The method includes: receiving information related to one or more UEs; and transmitting configuration information for a sidelink positioning reference signal, based on information related to at least one of the one or more UEs among the information related to the one or more UEs.

In some implementations, for example, the information related to the one or more UEs includes at least UE identities (IDs) of the one or more UEs.

In some implementations, for example, each of the UE ID includes at least one of:
a NGAP ID;
a ProSe application code or ProSe application code prefix;
a ProSe restricted code or ProSe restricted code prefix;
a ProSe response code or ProSe query code;
a source or destination layer-2 ID;
a source or destination layer-2 ID for direct discovery;
a source or destination layer-2 ID for direct discovery;
a source or destination layer-2 ID for relay discovery;
a source or destination layer-2 ID for relay communication;
a relay service code;
a new ProSe identity; or
a new sidelink positioning identity.

In some implementations, for example, the configuration information for the sidelink positioning reference signal includes at least one of:
a start frequency point of the sidelink positioning reference signal;
a bandwidth of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a resource number of symbols of the sidelink positioning reference signal;
a starting time of transmission of the sidelink positioning reference signal; or
a duration of the transmission of the sidelink positioning reference signal.

In some implementations, for example, the configuration information for the sidelink positioning reference signal is generated by a distributed unit of the third node in response to a request of a central unit of the third node.

In some implementations, for example, the method further includes: receiving, from a second node, a first request message for requesting activation or deactivation of one or at least one of the configured one or more sidelink positioning reference signals; and in response to the first request message, transmitting, to the second node, a first response message for activating or deactivating transmission of the one or the at least one of the one or more sidelink positioning reference signals.

In some implementations, for example, a message for activating or deactivating transmission of the one or the at least one of the one or more sidelink positioning reference signals is generated by the distributed unit of the third node in response to the request of the central unit of the third node.

In some implementations, for example, the method further includes: transmitting, to a fourth node, a request message for requesting at least one UE ID, and in response to the request message for requesting the at least one UE ID, receiving, from the fourth node, a response message including the at least one UE ID.

In some implementations, for example, each of the at least one UE ID includes at least one of:
a NGAP ID;
a ProSe application code or ProSe application code prefix;
a ProSe restricted code or ProSe restricted code prefix;
a ProSe response code or ProSe query code;
a source or destination layer-2 ID;
a source or destination layer-2 ID for direct discovery;
a source or destination layer-2 ID for direct discovery;
a source or destination layer-2 ID for relay discovery;
a source or destination layer-2 ID for relay communication;
a relay service code;
a new ProSe identity; or
a new sidelink positioning identity.

In some implementations, for example, the method further includes: receiving, from a fifth node, information indicating a status of the fifth node; and transmitting, to the second node, information indicating the status of the fifth node and/or information for releasing one or at least one of the one or more configured sidelink positioning reference signals.

In some implementations, for example, the method further includes: transmitting, from the third node to a new third node or fourth node, information indicating whether the first node or the fifth node is used as a UE for the sidelink positioning.

In some implementations, for example, the method further includes: receiving, from the first node or the fifth node, information related to the sidelink positioning; and transmitting, to the first node or the fifth node, the information related to the sidelink positioning.

In some implementations, for example, the information related to the sidelink positioning includes at least one of: information indicating whether the first node or the fifth node can be used as an anchor UE, or identification information of the fifth node.

In some implementations, for example, the information related to the one or more UEs is received from at least one of the first node or the fifth node.

In some implementations, for example, the configuration information for the sidelink positioning reference signal is transmitted to at least one of the first node, the second node or the fifth node.

In some implementations, for example, the positioning reference signal is received from the fifth node by the first node based on the configuration information for the sidelink positioning reference signal, or the positioning reference signal is transmitted to the fifth node by the first node based on the configuration information for the sidelink positioning reference signal.

In some implementations, for example, the first node is a UE. For example, the UE may be a UE that has a positioning requirement/that is positioned/that performs sidelink positioning.

In some implementations, for example, the second node is a Location Management Function (LMF).

In some implementations, for example, the third node is a base station.

In some implementations, for example, the fourth node is an Access and Mobility Management Function (AMF).

In some implementations, for example, the fifth node is another UE. For example, the another UE may be a UE for supporting or assisting or participating in the sidelink positioning of the first node.

According to at least one embodiment of the disclosure, there is also provided a first node in a wireless communication system. The first node includes a transceiver configured to transmit and receive signals; and a controller coupled to the transceiver and configured to perform one or more operations of the above-described methods performed by the first node.

According to at least one embodiment of the disclosure, there is also provided a second node in a wireless communication system. The second node includes a transceiver configured to transmit and receive signals; and a controller coupled to the transceiver and configured to perform one or more operations of the above-described methods performed by the second node.

According to at least one embodiment of the disclosure, there is also provided a third node in a wireless communication system. The third node includes a transceiver configured to transmit and receive signals; and a controller coupled to the transceiver and configured to perform one or more operations of the above-described methods performed by the third node.

According to at least one embodiments of the disclosure, there is also provided a computer-readable storage medium having one or more computer programs stored thereon, which, when executed by one or more processors, can implement any of the above-described methods.

There is provided a method and an apparatus for positioning in a wireless communication system. The method includes: receiving information related to one or more user equipments (UEs); based on information related to at least one of the one or more UEs among the information related to the one or more UEs, transmitting a first request message to a third node for requesting the third node to configure a sidelink positioning reference signal; in response to the first request message, receiving a first response message from the third node, where the first response message includes configuration information for the sidelink positioning reference signal; and transmitting the configuration information for the sidelink positioning reference signal. The invention at least provides a configuration method of a reference signal for sidelink positioning.

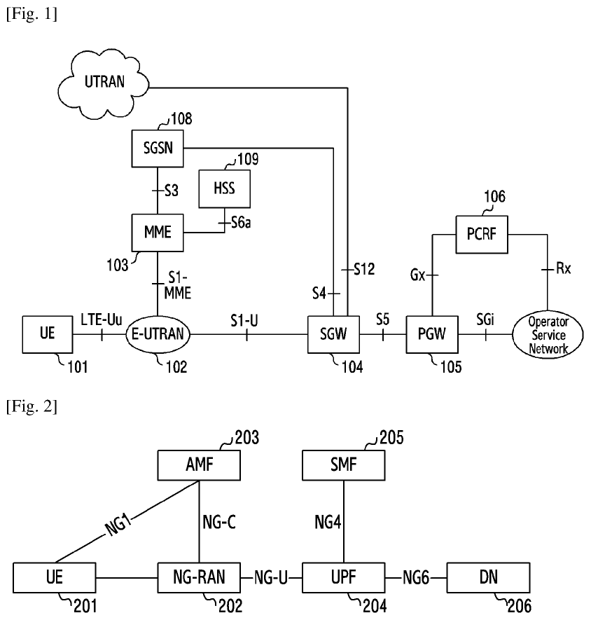

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the disclosure. Other embodiments of the system architecture 200 can be used without departing from the scope of the disclosure.

Referring to FIG. 2, according to an embodiment, user equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the disclosure are further described below with reference to the accompanying drawings. For convenience of explanation, some terms and names defined in 3rd generation partnership project (3GPP), Long Term Evolution (LTE), Advanced LTE (LTE-A), Fifth Generation (5G) and New Radio (NR) standards may be used. However, the details of the disclosure are not limited by terms and names according to standards, and can be equally applied to systems according to other standards.

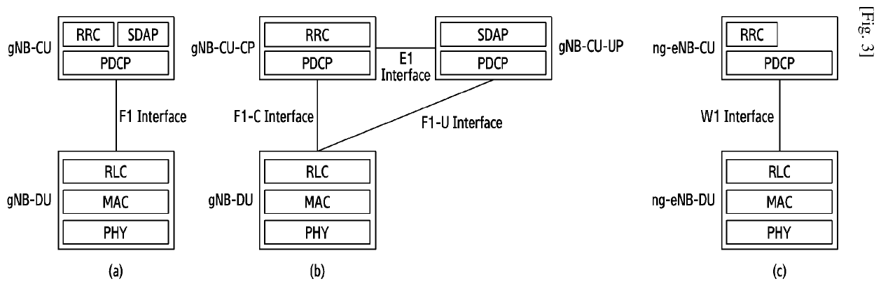

FIG. 3 illustrates a schematic diagram of the configuration of a distributed unit and a central unit of a base station according to an embodiment.

In NR systems, in order to support network function virtualization and more efficient resource management and scheduling, a base station (e.g., gNB/ng-eNB) that provides wireless network interfaces for terminals (e.g., UEs) can be further divided into a central unit (CU) (e.g., gNB-CU/ng-eNB-CU (gNB central unit/ng-eNB central unit)) and a distributed unit (DU) (for example, gNB-DU/ng-eNB-DU (gNB distributed unit/ng-eNB distributed unit), as shown in (a) of FIG. 3.

The gNB-CU has a radio resource control (RRC) layer, a service data adaptation protocol (SDAP) layer and a packet data convergence protocol (PDCP) layer, etc. The ng-eNB-CU has a RRC layer and a PDCP layer. The gNB-DU/ng-eNB-DU has a radio link control protocol (RLC) layer, a medium access control (MAC) layer and a physical layer, etc. There is a standardized open interface F1 between the gNB-CU and the gNB-DU, and a standardized open interface W1 between the ng-eNB-CU and the ng-eNB-DU. The F1 interface can be divided into a control plane F1-C and a user plane F1-U. The transport network layer of the F1-C is transmitted based on IP. In order to transmit signaling more reliably, a SCTP protocol is added above the IP. The protocol of an application layer can be F1AP. The SCTP can provide reliable transmission of the application layer message. The transport layer of the F1-U is UDP/IP, and GTP-U above the UDP/IP is used to carry user plane protocol data units (PDUs).

Further, for the gNB-CU, as shown in FIG. 3 (b), the gNB-CU may include a gNBCU-CP (a control plane part of the central unit of the base station) and a gNB-CU-UP (a user plane part of the central unit of the base station). The gNB-CU-CP contains functions of the control plane of the base station, with the RRC layer and the PDCP protocol layer, and the gNB-CU-UP contains functions of the user plane of the base station, with the SDAP layer and the PDCP protocol layer. There is a standardized open interface E1 between the gNB-CU-CP and the gNB-CU-UP, and the protocol can be E1AP. The interface between the control plane part of the central unit of the base station and the distributed unit of the base station is a F1-C interface, that is, a control plane interface of F1; the interface between the user plane part of the central unit of the base station and the distributed unit of the base station is a F1-U interface, that is, a user plane interface of F1.

In NR systems, a base station that provides a E-UTRA user plane and a control plane and accesses a 5G core network can be called ng-eNB. In order to support virtualization, such base station (ng-eNB) may also be further divided into a central unit ngeNB-CU (gNB central unit/ng-eNB central unit) and a distributed unit ng-eNB-DU (gNB distributed unit/ng-eNB distributed unit) (abbreviated as CU and DU in embodiments of the disclosure), as shown in (c) of FIG. 3. The ng-eNB-CU has a RRC layer and a PDCP layer. The gNB-DU/ng-eNB-DU has a radio link control protocol (RLC) layer, a medium access control (MAC) layer and a physical layer, etc. There is a standardized open interface W1 between the ng-eNB-CU and the ng-eNB-DU. The W1 interface can be divided into a control plane W1-C and a user plane W1-U. The transport network layer of the W1-C is transmitted based on IP. In order to transmit signaling more reliably, the SCTP protocol is added over the IP. The protocol of an application layer can be W1AP. The transport layer of the W1-U is UDP/IP, and the GTP-U above the UDP/IP is used to carry user plane protocol data units (PDUs).

At present, the research of 5G network positioning mainly focuses on NR positioning, and the research of the positioning method of terminal direct communication is just in its infancy. At present, the research mainly focuses on exploring whether the potential method of sidelink (SL) positioning can meet the requirements of accuracy, reliability, delay and so on in typical scenarios, and has not studied the influence of sidelink positioning on interfaces of base stations and processes of protocols. The embodiments of the disclosure mainly relate to the definition of base station interfaces/air interfaces and processes of protocols for sidelink positioning, so as to support the basic requirements of sidelink positioning communication. For example, according to some embodiments of the disclosure, a method of capability transfer of an anchor/reference/assistance/observation/positioning/positioning participant/location server terminal is provided. According to some embodiments of the disclosure, a configuration method of a sidelink positioning reference signal is also provided. According to some embodiments of the disclosure, an activation/deactivation method of a sidelink positioning reference signal is also provided. According to some embodiments of the disclosure, a method for identifying a request and a response by a terminal is also provided. According to some embodiments of the disclosure, an operation method considering terminal mobility is also provided. According to some embodiments of the disclosure, a method of status updating/modification of an anchor/reference/assistance/observation/positioning/positioning participant/location server terminal is also provided.

It should be noted that the “sidelink positioning” in this document may include absolute positioning, relative positioning, ranging, etc., unless otherwise specified.

Before introducing the specific content, some assumptions and some definitions in embodiments of the disclosure are given below.

The message names in embodiments of the disclosure are just examples, and other message names may be used.

The “first” and “second” included in message names in embodiments of the disclosure are only examples of messages and do not represent the order of execution.

In embodiments of the disclosure, a detailed description of steps unrelated to the embodiments of the disclosure may be omitted.

In embodiments of the disclosure, steps in each flow can be performed in combination with each other or independently. The order of execution in each flow are only examples, and other possible orders of execution are not excluded.

In embodiments of the disclosure, the “base station” may be a 5G base station (such as gNB, ng-eNB). Alternatively, the “base station” may also be a 4G base station (such as an eNB), a 6G base station, or other types of access nodes.

In embodiments of the disclosure, transmission of data may refer to receiving or transmitting the data.

In embodiments of the disclosure, the terms “identity (ID)”, “identifier” and “identification information” can be used interchangeably.

For the convenience of description, in embodiments of the disclosure, the “target terminal” or “target UE” is used to represent a terminal/UE that has a positioning requirement or performs sidelink positioning. For example, in embodiments of the disclosure, the “target terminal” or “target UE” can be replaced with “a terminal/UE that has a positioning requirement/that is positioned/that performs sidelink positioning.”

For the convenience of description, in embodiments of the disclosure, an “anchor terminal” or “anchor UE” is used to represent a terminal/UE for supporting a target terminal/UE to perform sidelink positioning, or a terminal/UE for assisting a target terminal to perform sidelink positioning, or a terminal/UE participating in sidelink positioning of a target terminal/UE. For example, in the embodiments of the disclosure, an “anchor terminal” or “anchor UE” can be replaced with an “anchor/reference/assistance/observation/positioning/positioning participant/location server terminal/UE” or replaced with “terminal/UE”.

For the convenience of description, nodes including a first node to a sixth node involved in the embodiments of the disclosure are defined respectively.

First node: a user terminal, which may be a target UE for sidelink positioning. For example, in embodiments of the disclosure, a target UE may refer to a UE that has a positioning requirement/that is positioned/that performs sidelink positioning.

Second node: a Location Management Function (LMF).

Third node: a base station, or a central unit of the base station, or a control plane part of the central unit of the base station, or a user plane part of the central unit of the base station.

Fourth node: an Access and Mobility Management Function (AMF).

Fifth node: an anchor UE, which may be a UE for supporting a target UE to perform sidelink positioning, or a UE for assisting a target UE to perform sidelink positioning, or a UE participating in sidelink positioning of a target UE.

Sixth node: a Proximity-based Service Function (ProSe Function).

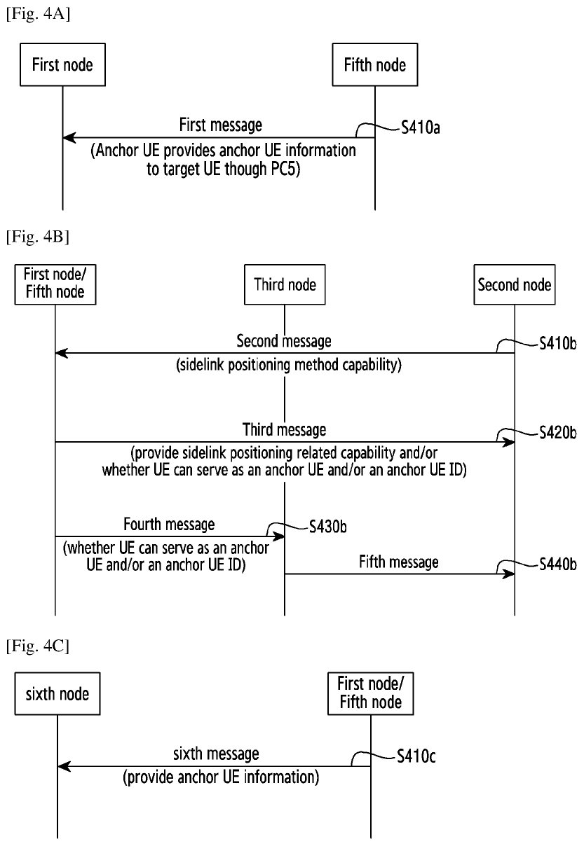

In the scenario of direct communication (such as V2X), potential terminals for direct communication may be found through a ProSe Direct Discovery process. However, the existing direct communication process may not consider the function of an anchor UE supporting a target UE to perform sidelink positioning, so the terminal as the anchor cannot provide information that itself can be used as an anchor UE to the network or the target UE with direct communication and positioning requirements, resulting in the lack of information on the network side and the target UE, which affects the normal operation of the sidelink positioning function. In order to at least solve this problem, the embodiments of the disclosure provide a method of capability transfer by the anchor UE, so as to ensure that the network side and the target UE can know the existence of the anchor UE as soon as possible. Hereinafter, a method of anchor UE capability transfer according to some embodiments of the disclosure will be described in conjunction with FIGS. 4A-4C.

FIG. 4A illustrates a schematic diagram of a method of anchor UE capability transfer according to some embodiments of the disclosure.

Referring to FIG. 4A, in step S410a, a fifth node transmits a first message including information related to the fifth node to a first node to report a capability of the fifth node related to sidelink positioning, for example, a capability whether to support to serve as an anchor UE. For example, the information related to (or, associated with) the fifth node may at least include one or more of the following information:
indication information indicating that the fifth node can serve as an anchor UE;
indication information indicating that the fifth node no longer serves as an anchor UE;
indication information indicating whether the fifth node can serve as an anchor UE; or
identification information of the fifth node serving as an anchor UE.

In some implementations, the identification information of the fifth node included in the first message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

In some implementations, the first message may be a ProSe PC 5 Discovery message, or a ProSe direct Communication related message, or other existing or newly defined ProSe messages.

After receiving the first message, the first node can use the information related to the anchor UE (in embodiments of the disclosure, which may also be referred to as UE-related information) in the first message to select an anchor UE or a potential anchor UE that supports the first node to realize sidelink positioning.

FIG. 4B illustrates a schematic diagram of a method of anchor UE capability transfer according to some embodiments of the disclosure.

As shown in FIG. 4B, in step S410b, a second node transmits a second message to a fifth node/first node, where the second message includes request information for requesting the fifth node/first node to report a capability related to sidelink positioning methods (for example, supported sidelink positioning methods).

In some implementations, the request information included in the second message may at least include one or more of the following information:
request information for a capability of sidelink positioning based on time difference of arrival (TDOA);
request information for a capability of sidelink positioning based on angle of departure (AoD);
request information for a capability of sidelink positioning based on angle of arrival (AoA);
request information for a capability of sidelink positioning based on multi-roundtrip time (RTT); or
request information for a capability of sidelink positioning.

In some implementations, the second message may be an LPP request Capabilities message, or other or newly defined LPP messages.

After receiving the second message, the fifth node/first node may report capability information to the network by adopting one of a first approach and a second approach. For example, the first approach may include step S420b. For example, the second approach may include steps S430b and S440b.

Continuing to refer to FIG. 4B, in the first approach, the fifth node/first node may transmit a third message including the capability information to the second node in step S420b, for example, in response to the request information transmitted by the second node in step S410b. For example, the capability information may include one or more of the following:
a capability related to sidelink positioning methods supported by the fifth node/the first node;
capability information indicating whether the fifth node/first node supports to serve as an anchor UE;
capability information indicating that the fifth node/first node supports sidelink positioning based on TDOA;
capability information indicating that the fifth node/first node supports sidelink positioning based on AoD;
capability information indicating that the fifth node/first node supports sidelink positioning based on AoA;
capability information indicating that the fifth node/first node supports sidelink positioning based on multi-RTT;
capability information indicating capabilities related to sidelink positioning which are supported by the fifth node/first node; or
identification information of the fifth node, in case that the second message in step S410b is received by the fifth node.

As some examples, the identification information of the fifth node included in the third message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

In some implementations, the third message may be a LPP Provide Capabilities message, or other or newly defined LPP messages.

Continuing to refer to FIG. 4B, in the second approach, the fifth node/first node transmits a fourth message to the third node in step S430b, where the fourth message includes information indicating whether the fifth node/first node supports to serve as an anchor UE and/or identification information of the fifth node, so as to report to the third node the capability whether to support to serve as an anchor UE. The fourth message may be SidelinkUEInformationNR or UEPositioningAssistanceInfo or UECapabilityInformation defined in existing RRC signaling or other RRC messages.

For example, the identification information of the fifth node included in the fourth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 4B, after receiving the fourth message, the third node transmits a fifth message to the second node, where the fifth message includes information indicating whether the corresponding fifth node/first node supports to serve as an anchor UE and/or identification information of the fifth node. The fifth message may be a newly defined NRPPa message. For example, the identification information of the fifth node included in the fifth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

FIG. 4C illustrates a schematic diagram of a method of anchor UE capability transfer according to some embodiments of the disclosure.

As shown in FIG. 4C, in step S410c, a first node/fifth node transmits a sixth message to a sixth node, where the sixth message includes capability information related to sidelink positioning. For example, the capability information may at least include one or more of the following information:
whether the first node/fifth node supports to perform sidelink positioning;
whether the first node/fifth node supports sidelink positioning based on TDOA;
whether the first node/fifth node supports sidelink positioning based on AoD;
whether the first node/fifth node supports sidelink positioning based on AoA;
whether the first node/fifth node supports sidelink positioning based on multi-RTT; or
whether the first node/fifth node supports to serve as an anchor UE.

In some implementations, the sixth message may be a ProSe Authorization Request message, or may be a ProSe Discovery Request message, or an existing or newly defined ProSe message.

After receiving the sixth message, the sixth node may transmit the content in the sixth message to a second node via a fourth node. In this way, the second node can know the capability information related to sidelink positioning supported by the first node/fifth node and/or information about whether the first node/fifth node supports to serve as an anchor UE.

At the same time, after receiving the sixth message, the sixth node may configure more reasonable ProSe Direct Discovery related parameters for the first node/fifth node according to content in the sixth message. For example, for the restricted discovery, the target UE and the anchor UE that can cooperate to complete sidelink positioning can be configured to allow discovery and direct communication. The relevant configuration parameters involved include but are not limited to identification information of a ProSe Direct Discovery and/or Discovery filter and so on.

The methods of anchor UE capability transfer according to some embodiments of the disclosure has been described above. Through the methods, it can be ensured that the network side and the target UE know the existence of the anchor UE as early as possible, so as to facilitate the implementation of sidelink positioning.

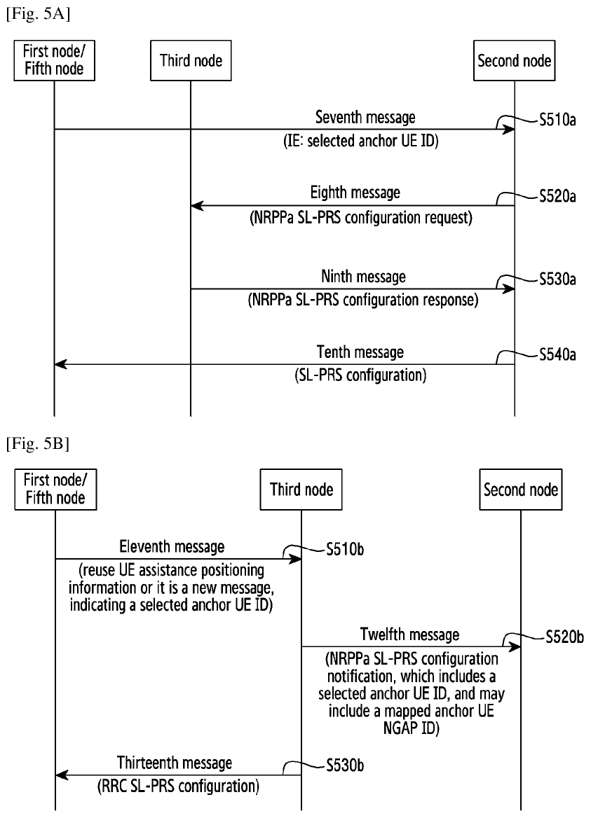

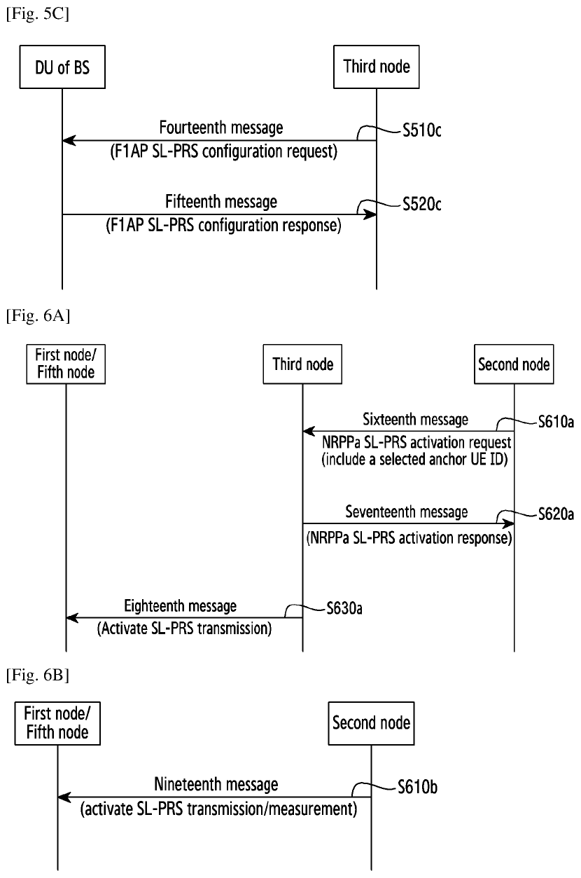

Sidelink positioning or measurement may require the use of reference signals. It is necessary to consider how to configure a reference signal for sidelink positioning (in embodiments of the disclosure, which may be referred to as a sidelink positioning reference signal (SL-PRS)), so as to realize the basic function of sidelink positioning. Therefore, some embodiments of the disclosure provide a configuration method of a sidelink reference signal to ensure the configuration of the sidelink positioning reference signal on a suitable node, thereby facilitating the sidelink positioning and measurement. The configuration methods of a sidelink reference signal according to embodiments of the disclosure will be described with reference to FIGS. 5A to 5C.

FIG. 5A illustrates a schematic diagram of a configuration method of a sidelink reference signal according to some embodiments of the disclosure.

Referring to FIG. 5A, in step S510a, a first node transmits a seventh message to a second node. The function of the seventh message is to provide the network side with information related to all or part of anchor UEs discovered by the first node. For example, the seventh message may be an LPP Request Assistance Data message, or may also be other existing LPP messages or a newly defined LPP message.

According to an embodiment, the seventh message may include information related to one or more anchor UEs.

As some examples, the information related to the one or more anchor UEs included in the seventh message may at least include one or more of the following information:
identification information of anchor UE(s) selected by the first node;
identification information of anchor UE(s) discovered by the first node; or
identification information of potential anchor UE(s) determined by the first node.
identification information of the first node.

For example, the identification information of the anchor UE or the identification information of the first node may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 5A, after receiving the seventh message, in step S520a, based on content in the seventh message, the second node transmits an eighth message to a third node to which the anchor UE or the target UE is connected, for requesting the third node to configure a sidelink positioning reference signal. The eighth message may be an existing NRPPa Positioning Information Request message, or may also be a new NRPPa message. For example, based on whether the sidelink positioning reference signal is transmitted by an anchor UE or by a target UE, different new NRPPa sidelink positioning reference signal request messages may be defined, or the same new NRPPa sidelink positioning reference signal request messages may also be defined.

In some implementations, the eighth message may include information for requesting the third node to configure the sidelink positioning reference signal.

As some examples, the information for requesting the third node to configure the sidelink positioning reference signal included in the eighth message may at least include one or more of the following information:
identification information of selected anchor UE(s);
requested sidelink positioning reference signal transmission characteristics; or
NGAP ID information corresponding to the anchor UE.

As mentioned above, the NGAP ID information corresponding to the anchor UE may be included in the eighth message. Alternatively, the NGAP ID information corresponding to the anchor UE may not be included in the eighth message but included in an existing NGAP message.

As some examples, the characteristics of the sidelink positioning reference signal included in the eighth message may at least include one or more of the following information:
a starting frequency point of the sidelink positioning reference signal;
a bandwidth of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a resource number of symbols of the sidelink positioning reference signal;
a starting time of transmission of the sidelink positioning reference signal; or
a duration of the transmission of the sidelink positioning reference signal.

As some examples, the identification information of the selected anchor UE included in the eighth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 5A, after receiving the eighth message, the third node may configure the sidelink positioning reference signal according to content in the eighth message, and may transmit a ninth message as a response in step S530a. Depending on whether the configuration of the sidelink positioning reference signal is successful and/or whether the sidelink positioning reference signal needs to be updated, the content included in the ninth message may be different.

For example, in case that the third node successfully configures the sidelink positioning reference signal, the third node transmits the ninth message to the second node, where the ninth message includes at least configuration information for the sidelink positioning reference signal. In this case, the main purpose of the ninth message is to respond to the request of the second node to provide the configuration of the sidelink positioning reference signal. The ninth message may be an existing NRPPa Positioning Information Response message, or a new NRPPa message. For example, based on whether the sidelink positioning reference signal is transmitted by an anchor UE or by a target UE, different new NRPPa sidelink positioning reference signal response messages may be defined, and the same new NRPPa sidelink positioning reference signal response message may also be defined.

In some implementations, the configuration information for the sidelink positioning reference signal included in the ninth message may at least include one or more of the following information:
a subcarrier spacing of the sidelink positioning reference signal;
a starting frequency point of the sidelink positioning reference signal;
a bandwidth of the sidelink positioning reference signal;
a number of PRBs occupied by a resource of the sidelink positioning reference signal;
an offset of an available resource of the sidelink positioning reference signal relative to the starting frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

If the third node fails to configure the sidelink positioning reference signal, the third node transmits the ninth message to the second node, where the ninth message includes information indicating that the configuration fails. In this case, the main purpose of the ninth message is to respond with configuration failure to the request of the second node. The ninth message may be an existing NRPPa Positioning Information Failure message, or a new NRPPa message. For example, based on whether the sidelink positioning reference signal is transmitted by an anchor UE or by a target UE, different new NRPPa sidelink positioning reference signal response failure messages may be defined, and the same new NRPPa sidelink positioning reference signal response failure messages may also be defined.

If the configuration of the sidelink positioning reference signal needs to be updated, the third node may transmit the ninth message to the second node, where the ninth message includes updated configuration information for the sidelink positioning reference signal. In this case, the main purpose of the ninth message is to update the configured sidelink positioning reference signal. The ninth message may be an existing NRPPa Positioning Information Update message, or a new NRPPa message. For example, based on whether the sidelink positioning reference signal is transmitted by an anchor UE or by a target UE, different new NRPPa sidelink positioning reference signal update messages may be defined, and the same new NRPPa sidelink positioning reference signal update messages may also be defined.

In some implementations, the updated configuration information for the sidelink positioning reference signal included in the ninth message may at least include one or more of the following information:
a subcarrier spacing of the sidelink positioning reference signal;
a starting frequency point of the sidelink positioning reference signal;
a bandwidth of the sidelink positioning reference signal;
a number of PRBs occupied by a resource of the sidelink positioning reference signal;
an offset of an available resource of the sidelink positioning reference signal relative to the starting frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

Continuing to refer to FIG. 5A, after receiving the ninth message, the second node transmits a tenth message to the fifth node/first node in step S540a according to content in the ninth message, for providing the fifth node/the first node with configuration information for the sidelink positioning reference signal. For example, the tenth message may be an existing LPP Provide Assistance Data message, or may also be other existing LPP messages or a newly defined LPP message.

In some implementations, the tenth message may include one or more of the following information:
configuration information for the sidelink positioning reference signal; or
identification information of selected anchor UE(s).
indication information indicating or requiring the first node to provide a new set of identification information of anchor UEs.
identification information of the first node, in case that the tenth message is transmitted to the fifth node.

As some examples, the configuration information for the sidelink positioning reference signal included in the tenth message may at least include one or more of the following information:
a subcarrier spacing of the sidelink positioning reference signal;
a starting frequency point of the sidelink positioning reference signal;
a bandwidth of the sidelink positioning reference signal;
a number of PRBs occupied by a resource of the sidelink positioning reference signal;
an offset of an available resource of the sidelink positioning reference signal relative to the starting frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

As some examples, the identification information of the selected anchor UE or the identification information of the first node included in the tenth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

FIG. 5B illustrates a schematic diagram of a configuration method of a sidelink reference signal according to some embodiments of the disclosure.

As shown in FIG. 5B, in step S510b, a first node transmits an eleventh message to a third node. The purpose of the eleventh message is to provide the network side with information related to all or part of anchor UEs discovered by the first node. The eleventh message may be SidelinkUEInformationNR or UEPositioningAssistanceInfo or UECapabilityInformation defined in existing RRC signaling or other RRC messages.

In some implementations, the eleventh message may include information related to one or more anchor UEs.

The eleventh message may further include identification information of the first node.

As some examples, the information related to the one or more anchor UEs included in the eleventh message may at least include one or more of the following information:
identification information of anchor UE(s) selected by the first node;
identification information of anchor UE(s) discovered by the first node; or
identification information of potential anchor UE(s) determined by the first node.

For example, the identification information of the anchor UE or the identification information of the first node may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 5B, after receiving the eleventh message, the third node can configure a sidelink positioning reference signal for the anchor UE/target UE according to content in the eleventh message, and transmit a twelfth message to the second node in step S520b, for providing the second node with a configuration of the sidelink positioning reference signal. For example, the twelfth message may be an existing NRPPa message, or may also be a new NRPPa notification message. For example, based on whether the sidelink positioning reference signal is transmitted by an anchor UE or by a target UE, different new NRPPa sidelink positioning reference signal notification messages may be defined, or the same new NRPPa sidelink positioning reference signal notification messages may also be defined.

In some implementations, the twelfth message may at least include one or more of the following information:
configuration information for the sidelink positioning reference signal;
identification information of the selected anchor UE; or
NGAP ID information corresponding to the anchor UE.

As mentioned above, the NGAP ID information corresponding to the anchor UE may be included in the twelfth message. Alternatively, the NGAP ID information corresponding to the anchor UE may not be included in the twelfth message but included in an existing NGAP message.

As some examples, the configuration information for the sidelink positioning reference signal included in the twelfth message may at least include one or more of the following information:
a subcarrier spacing of the sidelink positioning reference signal;
a starting frequency point of the sidelink positioning reference signal;
a bandwidth of the sidelink positioning reference signal;
a number of PRBs occupied by a resource of the sidelink positioning reference signal;
an offset of an available resource of the sidelink positioning reference signal relative to the starting frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

As some examples, the identification information of the selected anchor UE included in the twelfth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 5B, after receiving the eleventh message, the third node can configure the sidelink positioning reference signal according to content in the eleventh message, and transmit a thirteenth message to the fifth node/first node, for providing the configuration of the sidelink positioning reference signal to the fifth node/first node in response. For example, the thirteenth message may be an existing RRC Reconfiguration message, or may also be other existing RRC messages or newly defined RRC messages.

In some implementations, the thirteenth message may at least include one or more of the following information:
configuration information for the sidelink positioning reference signal; or
identification information of the selected anchor UE.
identification information of the first node, in case that the thirteenth message is transmitted to the fifth node.

As some examples, the configuration information for the sidelink positioning reference signal included in the thirteenth message may at least include one or more of the following information:
a subcarrier spacing of the sidelink positioning reference signal;
a starting frequency point of the sidelink positioning reference signal;
a bandwidth of the sidelink positioning reference signal;
a number of PRBs occupied by a resource of the sidelink positioning reference signal;
an offset of an available resource of the sidelink positioning reference signal relative to the starting frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

As some examples, the identification information of the selected anchor UE or the identification information of the first node included in the thirteenth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

FIG. 5C illustrates a schematic diagram of a configuration method of a sidelink reference signal according to some embodiments of the disclosure. In the embodiment described in conjunction with FIG. 5C, a third node may be a central unit of a base station, or a control plane part of the central unit of the base station, or a user plane part of the central unit of the base station.

As shown in FIG. 5C, in step S510c, the third node transmits a fourteenth message to a distributed unit of the base station, for requesting the distributed unit of the base station to configure the sidelink positioning reference signal. The fourteenth message may be an existing F1AP Positioning Information Request message, or may also be a new F1AP message. For example, based on whether the sidelink positioning reference signal is transmitted by an anchor UE or a target UE, different new sidelink positioning reference signal request messages on the F1AP may be defined, or the same new sidelink positioning reference signal request messages on the F1AP may also be defined.

In some implementations, the fourteenth message may at least include requested sidelink positioning reference signal transmission characteristics.

As some examples, the requested sidelink positioning reference signal transmission characteristics included in the fourteenth message may at least include one or more of the following information:
a starting frequency point of the sidelink positioning reference signal;
a bandwidth of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a resource number of symbols of the sidelink positioning reference signal;
a starting time of transmission of the sidelink positioning reference signal; or
a duration of the transmission of the sidelink positioning reference signal.

Continuing to refer to FIG. 5C, after receiving the fourteenth message, the distributed unit of the base station can configure the sidelink positioning reference signal according to content in the fourteenth message, and transmit a fifteenth message to the third node in step S520c. For example, depending on whether the configuration of the link positioning reference signal is successful and/or whether the sidelink positioning reference signal needs to be updated, the content included in the fifteenth message may be different.

If the configuration of the sidelink positioning reference signal is successful, the distributed unit of the base station may transmit the fifteenth message to the third node, where the fifteenth message may at least include configuration information for the sidelink positioning reference signal. In this case, the main purpose of the fifteenth message is to respond to the request of the third node to provide the configuration of the sidelink positioning reference signal. The fifteenth message may be an existing F1AP Positioning Information Response message or a new F1AP message. For example, based on whether the sidelink positioning reference signal is transmitted by an anchor UE or by a target UE, different new F1AP sidelink positioning reference signal response messages may be defined, or the same new F1AP sidelink positioning reference signal response messages may also be defined.

In some implementations, the configuration information for the sidelink positioning reference signal included in the fifteenth message may at least include one or more of the following information:
a subcarrier spacing of the sidelink positioning reference signal;
a starting frequency point of the sidelink positioning reference signal;
a bandwidth of the sidelink positioning reference signal;
a number of PRBs occupied by a resource of the sidelink positioning reference signal;
an offset of an available resource of the sidelink positioning reference signal relative to the starting frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

If the configuration of the sidelink positioning reference signal fails, the distributed unit of the base station may transmit the fifteenth message to the third node, where the fifteenth message includes information indicating that the configuration fails. In this case, the main purpose of the fifteenth message is to respond with configuration fail to the request of the third node. For example, the fifteenth message may be an existing F1AP Positioning Information Failure message, or may also be a new F1AP message. For example, based on whether the sidelink positioning reference signal is transmitted by an anchor UE or by a target UE, different new F1AP sidelink positioning reference signal response failure messages may be defined, or the same new F1AP sidelink positioning reference signal response failure messages may also be defined.

If the configuration of the sidelink positioning reference signal needs to be updated, the distributed unit of the base station may transmit the fifteenth message to the third node, and the fifteenth message may at least include updated configuration information for the sidelink positioning reference signal. In this case, the main purpose of the fifteenth message is to update the configured sidelink positioning reference signal. For example, the fifteenth message may be an existing F1AP Positioning Information Update message, or may also be a new F1AP message. For example, based on whether the sidelink positioning reference signal is transmitted by an anchor UE or by a target UE, different new F1AP sidelink positioning reference signal update messages may be defined, or the same new F1AP sidelink positioning reference signal update messages may be defined.

In some implementations, the updated configuration information for the sidelink positioning reference signal included in the fifteenth message may at least include one or more of the following information:
a subcarrier spacing of the sidelink positioning reference signal;
a starting frequency point of the sidelink positioning reference signal;
a bandwidth of the sidelink positioning reference signal;
a number of PRBs occupied by a resource of the sidelink positioning reference signal;
an offset of an available resource of the sidelink positioning reference signal relative to the starting frequency point;
a resource element (RE) offset used by the resource of the sidelink positioning reference signal;
a comb size of the sidelink positioning reference signal;
a periodicity of the sidelink positioning reference signal;
a number of times that the sidelink positioning reference signal is transmitted;
a resource repetition factor of the sidelink positioning reference signal;
a slot offset used by the resource of the sidelink positioning reference signal;
a symbol offset used by the resource of the sidelink positioning reference signal;
a resource number of symbols of the sidelink positioning reference signal;
a starting time of transmission of the sidelink positioning reference signal; or
a duration of the transmission of the sidelink positioning reference signal.

The configuration method of the sidelink reference signal according to some embodiments of the disclosure has been described above. In this way, it can be ensured that the sidelink positioning reference signal is configured on a suitable node, thereby facilitating the sidelink positioning and measurement.

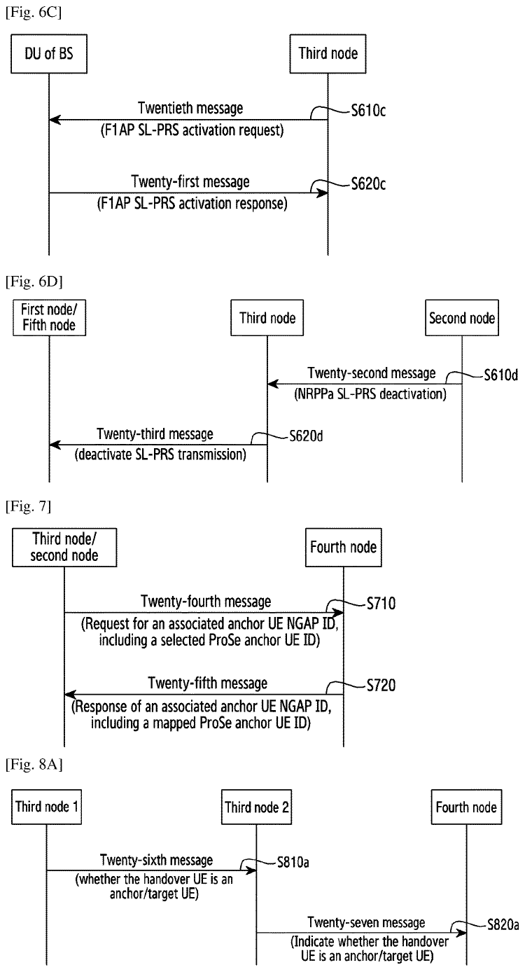

For a configured sidelink positioning reference signal, it is necessary to consider how to activate and deactivate it. In case that the method for activating and deactivating the sidelink positioning reference signal is not defined, it will affect the realization of the basic function of sidelink positioning. Therefore, the embodiments of the disclosure provide a method for activation and/or deactivation of a sidelink positioning reference signal, thereby facilitating the sidelink positioning and measurement. A method for activation and/or deactivation of a sidelink positioning reference signal according to some embodiments of the disclosure will be described with reference to FIGS. 6A to 6D.

FIG. 6A illustrates a schematic diagram of a method for activation and/or deactivation of a sidelink positioning reference signal according to some embodiments of the disclosure.

Referring to FIG. 6A, a second node transmits a sixteenth message to a third node, for requesting the third node to activate a configured sidelink positioning reference signal (SL-PRS). The sixteenth message may be an existing NRPPa Positioning Activation Request message, or may also be a new NRPPa message. For example, based on whether the sidelink positioning reference signal is transmitted by an anchor UE or by a target UE, different new NRPPa sidelink positioning reference signal activation request messages may be defined, or the same new NRPPa sidelink positioning reference signal activation request messages may also be defined.

According to an embodiment, the sixteenth message may at least include one or more of the following information:
information for requesting activation of the configured SL-PRS;
if there are multiple configured SL-PRSs, information indicating a SL-PRS that needs to be activated among the multiple configured SL-PRSs, such as identification information of the SL-PRS that needs to be activated; or
identification information of selected anchor UE(s). It should be noted that a set of the identification information of the selected anchor UEs in the sixteenth message may be a subset of the set of the identification information of the selected anchor UEs in the seventh message and the twelfth message.

As some examples, the identification information of the selected anchor UE included in the sixteenth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Referring to FIG. 6A, after receiving the sixteenth message, the third node may activate the configured sidelink positioning reference signal according to content of the sixteenth message, and may transmit a seventeenth message to the second node in step S620a in response. Depending on whether the configured sidelink positioning reference signal is activated successfully, the content included in the seventeenth message may be different.

For example, in case that the configured sidelink positioning reference signal is activated successfully, the third node may transmit the seventeenth message to the second node, for confirming that the activation of the configured sidelink positioning reference signal is successful. For example, in this case, the seventeenth message may include information confirming that the configured sidelink positioning reference signal is activated successfully. The seventeenth message may be an existing NRPPa Positioning Activation Response message, or may be a new NRPPa message. For example, based on whether the sidelink positioning reference signal is transmitted by an anchor UE or by a target UE, different new NRPPa sidelink positioning reference signal activation response messages may be defined, or the same new NRPPa sidelink positioning reference signal activation response messages may also be defined.

If the activation of the configured sidelink positioning reference signal fails, the third node may transmit the seventeenth message to the second node, for responding with activation fail to the request of the second node. For example, in this case, the seventeenth message may include information indicating that the activation of the configured sidelink positioning reference signal fails. The seventeenth message may be an existing positioning activation failure (NRPPa Positioning Activation Failure) message, or may be a new NRPPa message. For example, based on whether the sidelink positioning reference signal is transmitted by an anchor UE or by a target UE, different new NRPPa sidelink positioning reference signal activation failure messages may be defined, or the same new NRPPa sidelink positioning reference signal activation failure messages may also be defined.

Continuing to refer to FIG. 6A, in step S630a, the third node may transmit an eighteenth message to the fifth node/first node according to content of the sixteenth message, for activating the configured sidelink positioning reference signal of the fifth node/the first node (for example, activating transmission of the sidelink positioning reference signal). For example, the eighteenth message may be an existing RRC Reconfiguration message, or may be other existing RRC messages or a newly defined RRC message, or may also be a newly defined MAC CE.

In some implementations, the eighteenth message may at least include one or more of the following information:
information for activating the configured SL-PRS;
if there are multiple configured SL-PRS, information indicating a SL-PRS that needs to be activated among the multiple configured SL-PRSs, such as identification information of the SL-PRS that needs to be activated;
information indicating whether this message is used for activation or deactivation, in case that this message is used for both activation and deactivation; or
identification information of the first node, in case that the eighteenth message is transmitted to the fifth node.

As some examples, the identification information of the first node included in the eighteenth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

FIG. 6B illustrates a schematic diagram of a method for activation and/or deactivation of a sidelink positioning reference signal according to some embodiments of the disclosure.

As shown in FIG. 6B, in step S610b, a second node transmits a nineteenth message to a fifth node/first node, for activating or deactivating a configured sidelink positioning reference signal of a fifth node/first node, or instructing/indicating the fifth node/first node to measure the activated sidelink positioning reference signal, or instructing/indicating the fifth node/first node not to measure the configured sidelink positioning reference signal. For example, the nineteenth message may be an existing LPP Provide Assistance Data message, an LPP Request Location Information message, or other existing LPP messages or a newly defined LPP message information.

In some implementations, the nineteenth message may at least include one or more of the following information:
information indicating activation/deactivation of the configured SL-PRS;
if there are multiple configured SL-PRS, information indicating a SL-PRS that needs to be activated among the multiple configured SL-PRSs, such as identification information of the SL-PRS that needs to be activated;
information indicating that the configured SL-PRS needs to be measured/no longer measured;
if there are multiple configured SL-PRS, information indicating a SL-PRS that needs to be measured/no longer measured among the multiple configured SL-PRS, for example, identification information of the SL-PRS that needs to be measured/no longer measured; or
identification information of the first node, in case that the nineteenth message is transmitted to the fifth node.

As some examples, the identification information of the first node included in the nineteenth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

FIG. 6C illustrates a schematic diagram of a method for activation and/or deactivation of a sidelink positioning reference signal according to some embodiments of the disclosure. In the embodiment described in conjunction with FIG. 6C, a third node may be a central unit of a base station, or a control plane part of the central unit of the base station, or a user plane part of the central unit of the base station.

As shown in FIG. 6C, in step S610c, the third node transmits a twentieth message to a distributed unit of the base station, for requesting the distributed unit of the base station to activate the configured sidelink positioning reference signal. For example, the twentieth message may be an existing F1AP Positioning Activation Request message, or may also be a new F1AP message. For example, based on whether the sidelink positioning reference signal is transmitted by an anchor UE or by a target UE, different new F1AP sidelink positioning reference signal activation request messages may be defined, or the same new F1AP sidelink positioning reference signal activation request messages may also be defined.

In some implementations, the twentieth message may at least include one or more of the following information:
information for requesting activation of the configured SL-PRS;
if there are multiple configured SL-PRSs, information indicating a SL-PRS that needs to be activated among the multiple configured SL-PRSs, such as identification information of the SL-PRS that needs to be activated; or
identification information of the first node, in case that the twentieth message is transmitted to the fifth node.

As some examples, the identification information of the first node included in the twentieth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 6C, after receiving the twentieth message, the distributed unit of the base station may activate the configured sidelink positioning reference signal according to content in the twentieth message, and may transmit a twenty-first message in response in step S620c. Depending on whether the activation of the configured sidelink positioning reference signal is successful, the content of the twenty-first message may be different.

If the activation of the configured sidelink positioning reference signal is successful, the distributed unit of the base station transmits the twenty-first message to the third node, for responding with activation successful to the request of the third node. For example, in this case, the twenty-first message may include information confirming that the configured sidelink positioning reference signal is activated successfully. For example, the twenty-first message may be an existing F1AP Positioning Activation Response message, or a new F1AP message. For example, based on whether the sidelink positioning reference signal is transmitted by an anchor UE or by a target UE, different new F1AP sidelink positioning reference signal activation response messages may be defined, or the same new F1AP sidelink positioning reference signal activation response messages may also be defined.

If the activation of the configured sidelink positioning reference signal fails, the distributed unit of the base station transmits the twenty-first message to the third node for responding with activation failure to the request of the third node. For example, in this case, the twenty-first message may include information indicating that activation of the configured sidelink positioning reference signal fails. The twenty-first message may be an existing F1AP Positioning Activation Failure message, or may be a new F1AP message. For example, based on whether the sidelink positioning reference signal is transmitted by an anchor UE or by a target UE, different new F1AP sidelink positioning reference signal activation response failure messages may be defined, or the same new F1AP sidelink positioning reference signal activation response failure messages may also be defined.

FIG. 6D illustrates a schematic diagram of a method for activation and/or deactivation of a sidelink positioning reference signal according to some embodiments of the disclosure.

As shown in FIG. 6D, in step S610d, a second node transmits a twenty-second message to a third node, for instructing/indicating a third node to deactivate a configured sidelink positioning reference signal, or to release the configured sidelink positioning reference signal. For example, the twenty-second message may be an existing NRPPa Positioning Deactivation message, or a new NRPPa message. For example, based on whether the sidelink positioning reference signal is transmitted by an anchor UE or by a target UE, different new NRPPa sidelink positioning reference signal deactivation messages may be defined, or the same new NRPPa sidelink positioning reference signal deactivation messages may also be defined.

In some implementations, the twenty-second message may at least include one or more of the following information:
information indicating deactivation of the configured SL-PRS;
if there are multiple configured SL-PRS, information indicating a SL-PRS that needs to be activated among the multiple configured SL-PRSs, such as identification information of the SL-PRS that needs to be activated;
information indicating deactivation of all configured SL-PRS;
information indicating release of the configured SL-PRS;
if there are multiple configured SL-PRS, information indicating a SL-PRS that needs to be released among the multiple configured SL-PRSs, such as identification information of the SL-PRS that needs to be released; or
information indicating release of all configured SL-PRS.

Continuing to refer to FIG. 6D, in step S620d, the third node transmits a twenty-third message to the fifth node/first node according to the twenty-second message, for deactivating or releasing the sidelink positioning reference signal configured by the fifth node/the first node (for example, deactivating or releasing transmission of the sidelink positioning reference signal). For example, the twenty-third message may be an existing RRC Reconfiguration message, or may be other existing RRC messages or a newly defined RRC message, or may also be a newly defined MAC CE.

In some implementations, the twenty-second message includes at least one or more of the following information:
information for deactivating the configured SL-PRS;
if there are multiple configured SL-PRS, information indicating a SL-PRS that needs to be deactivated among the multiple configured SL-PRSs, such as identification information of the SL-PRS that needs to be deactivated;
information for deactivating all configured SL-PRS;
information for releasing the configured SL-PRS;
if there are multiple configured SL-PRS, information indicating a SL-PRS that needs to be released among the multiple configured SL-PRSs, such as identification information of the SL-PRS that needs to be released;
information for releasing all configured SL-PRS; or
information indicating whether this message is used for activation or deactivation/release, in case that this message is used for both activation and deactivation/release.

The methods for activation and deactivation of a sidelink positioning reference signal according to some embodiments of the disclosure has been described above. By defining the activation and deactivation way of the sidelink positioning reference signal, the methods facilitate the sidelink positioning and measurement.

In some cases, an anchor UE may be discovered by a target UE, and the target UE reports the discovered anchor UE to a network. However, identification information of the anchor UE discovered and reported by the target UE is a ProSe UE ID, which is only related to a sidelink (not related to sidelink positioning), and only the ProSe function in the network knows the correspondenc between the ProSe UE ID and the anchor UE. Therefore, when the target UE reports the ProSe UE ID of the anchor UE to the base station or LMF, the base station or LMF may not be able to identify the corresponding anchor UE according to the ProSe UE ID of the anchor UE, such that the base station or LMF cannot configure the corresponding anchor UE for subsequent sidelink positioning, which will affect the realization of the basic function of sidelink positioning. Therefore, the embodiments of the disclosure provide a method for identifying an anchor UE, so as to facilitate subsequent configuration related to sidelink positioning. A method for identifying an anchor UE according to some embodiments of the disclosure will be described below with reference to FIG. 7.

FIG. 7 illustrates a schematic diagram of a method for identifying an anchor UE according to some embodiments of the disclosure.

Referring to FIG. 7, in step S710, a third node/second node transmits a twenty-fourth message to a fourth node, for providing the fourth node with information related to all or part of anchor UEs determined or discovered or selected by a first node and requesting the fourth node to provide or feedback identification information of corresponding anchor UEs that the third node/second node can understand or recognize/identify. For example, the twenty-fourth message may be an existing NGAP message, or may also be a new NGAP message (when the twenty-fourth message in step S710 is transmitted by the third node to the fourth node); or the twenty-fourth message may be an existing NL1 message, or may also be a new NL1 message (when the twenty-fourth message in step S710 is transmitted by the second node to the fourth node).

According to an embodiment, the twenty-fourth message may include one or more of the following:
information related to one or more anchor UEs; or
information for requesting the fourth node to provide or feedback identification information of anchor UE(s) that the third node/second node can recognize/identify among the one or more anchor UEs.

As some examples, the information related to the one or more anchor UEs may at least include one or more of the following information:
identification information of anchor UE(s) selected by the first node;
identification information of anchor UE(s) discovered by the first node; or
identification information of potential anchor UE(s) determined by the first node.

For example, the identification information of the anchor UE may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 7, after receiving the twenty-fourth message, the fourth node can determine (for example, find) corresponding anchor UE(s) that the third node/second node can understand or recognize/identify according to content in the twenty-fourth message, and transmit a twenty-fifth message to the third node/second node in step S720, for indicating the corresponding anchor UE that the third node/second node can understand or recognize/identify. For example, the twenty-fifth message may include information indicating the corresponding anchor UE that the third node/second node can understand or recognize/identify. The purpose of the twenty-fifth information is to respond to the request of the third node/second node to provide the identification information of the corresponding anchor UE that can be understood or identified.

In some implementations, the information indicating the corresponding anchor UE that the third node/second node can understand or recognize/identify included in the twenty-fourth message may at least include one or more of the following information:
an AMF UE NGAP ID over a NG interface corresponding to the anchor UE;
a RAN UE NGAP ID over the NG interface corresponding to the anchor UE;
a Subscription Permanent Identifier (SUPI) corresponding to the anchor UE;
a Permanent Equipment Identifier (PEI) corresponding to the anchor UE;
a Generic Public Subscription Identifier (GPSI) corresponding to the anchor UE;
cell identification information corresponding to the anchor UE, for example, the cell identification information may be a Physical Cell Identity (PCI), a NR Cell Global Identity (NCGI), or other information that can identify a cell; or
base station node information corresponding to the anchor UE, for example, the base station node information may be a global RAN node ID or other information that can identify the base station node.

In some implementations, when the twenty-fifth message is to be transmitted to the third node, information requesting the third node to configure the corresponding anchor UE may also be included in the twenty-fifth message.

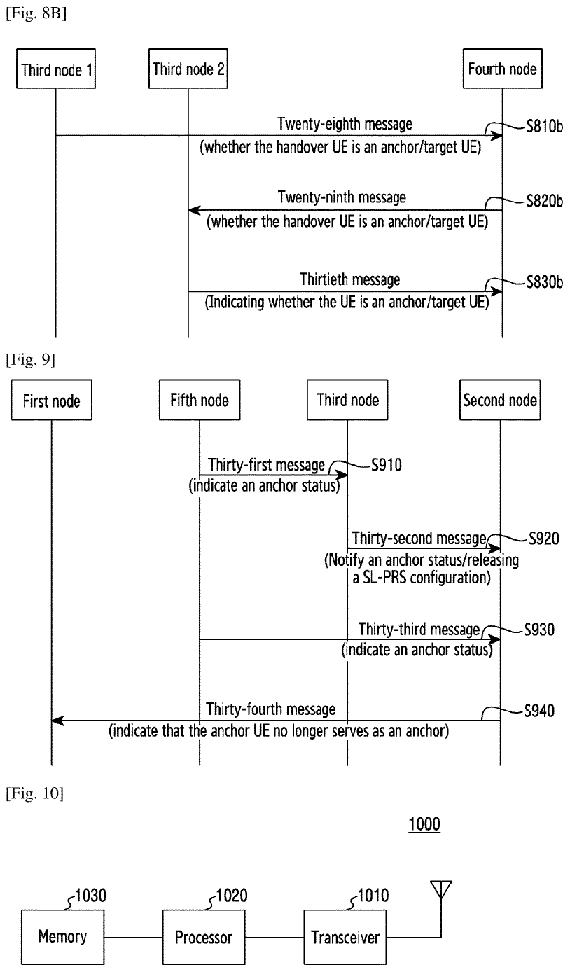

In some cases, an AMF may not store information on whether a certain UE is an anchor UE or a target UE for sidelink positioning. Therefore, in case that an anchor UE or a target UE hands over to another cell or base station node, the AMF will not actively inform a LMF that the corresponding anchor UE or the target UE has handed over to a new cell, therefore the AMF will not update the configuration of a sidelink positioning reference signal in time, which will affect the realization of the basic function of the sidelink positioning. Therefore, the embodiments of the disclosure provide an operation method considering UE mobility, so as to facilitate sidelink positioning configuration. An operation method considering UE mobility according to some embodiments of the disclosure will be described below with reference to FIGS. 8A and 8B.

FIG. 8A illustrates a schematic diagram of an operation method considering UE mobility according to some embodiments of the disclosure. For the embodiment in FIG. 8A, it is assumed that a UE (not shown) hands over from a third node 1 to a third node 2.

Referring to FIG. 8A, in step S810a, the third node 1 transmits a twenty-sixth message to the third node 2, for providing the third node 2 with information related to a UE performing handover. For example, the twenty-sixth message may be a Handover Request message defined in an existing XnAP message or other XnAP messages.

According to an embodiment, the information related to the UE performing handover included in the twenty-sixth message may at least include one or more of the following information:
information indicating that the UE is an anchor UE;
information indicating that the UE is a target UE; or
information indicating whether the UE is an anchor UE or a target UE.

Continuing to refer to FIG. 8A, after the third node 2 receives the twenty-sixth message, after the UE performing handover has handed over to the third node 2, the third node 2 transmits a twenty-seven message to the fourth node in step S820a, for providing the fourth node with information related to the UE that has completed the handover. For example, the twenty-seventh message may be a Path Switch Request message defined in an existing NGAP or other NGAP messages.

In some implementations, the information related to the UE that has completed the handover included in the twenty-seventh message may at least include one or more of the following information:
information indicating that the UE is an anchor UE;
information indicating that the UE is a target UE; or
information indicating whether the UE is an anchor UE or a target UE.

FIG. 8B illustrates a schematic diagram of an operation method considering UE mobility according to some embodiments of the disclosure. For the embodiment in FIG. 8B, it is assumed that a UE (not shown) hands over from a third node 1 to a third node 2.

As shown in FIG. 8B, in step S810b, the third node 1 transmits a twenty-eighth message to the fourth node, for providing the fourth node with information related to a UE performing handover. For example, the twenty-eighth message may be a Handover Required message defined in an existing NGAP or other NGAP messages.

In some implementations, the information related to the UE performing handover included in the twenty-eighth message includes at least one or more of the following information:
information indicating that the UE is an anchor UE;
information indicating that the UE is a target UE; or
information indicating whether the UE is an anchor UE or a target UE.

Continuing to refer to FIG. 8B, after receiving the twenty-eighth message, the fourth node transmits a twenty-ninth message to the third node 2 in step S820b, for providing the third node 2 with information related to the UE performing handover. For example, the twenty-ninth message may be a Handover Request message defined in an existing NGAP or other NGAP messages.

In some implementations, the information related to the UE performing handover included in the twenty-ninth message includes at least one or more of the following information:
information indicating that the UE is an anchor UE;
information indicating that the UE is a target UE; or
information indicating whether the UE is an anchor UE or a target UE.

Continuing to refer to FIG. 8B, after the third node 2 receives the twenty-ninth message, after the UE performing handover has handed over to the third node 2, the third node 2 transmits a thirtieth message to the fourth node in step S830b, for providing the fourth node with information related to the UE that has completed the handover. For example, the thirtieth message may be a Handover Notify message defined in an existing NGAP or other NGAP messages.

In some implementations, the information related to the UE that has completed the handover included in the thirtieth message may at least include one or more of the following information:
information indicating that the UE is an anchor UE;
information indicating that the UE is a target UE; or
information indicating whether the UE is an anchor UE or a target UE.

The above describes the operation methods considering UE mobility according to some embodiments of the disclosure. Through the methods, the configuration of the sidelink positioning reference signal can be updated in time when the UE hands over.

It may be determined by a positioning service application layer whether an anchor UE can be used as an anchor. Therefore, it is possible that a UE can continuously change in both anchor and non-anchor statuses, especially when the anchor UE can no longer support to serve as an anchor UE, which affects the effectiveness of a configured sidelink positioning reference signal. In order to solve at least the abovementioned problems, the embodiments of the disclosure provide a method of an anchor UE status updating/modification, thereby facilitating the updating/modification of a sidelink positioning configuration. Herein, “anchor UE status updating/modification” mentioned above may be replaced by “status updating/modification”. The method of an anchor UE status updating/modification according to some embodiments of the disclosure will be described below with reference to FIG. 9.

FIG. 9 illustrates a schematic diagram of a method of an anchor UE status updating/modification according to some embodiments of the disclosure.

Referring to FIG. 9, in step S910, a fifth node transmits a thirty-first message to a third node, for indicating a state/status of the fifth node to the third node, for example, the state/status of being an anchor UE (in embodiments of the disclosure, which may be referred to as anchor state/status). For example, the thirty-first message may be an existing RRC message (such as SidelinkUEInformationNR or UEPositioningAssistanceInfo), or may be other existing RRC messages or a new RRC message; or it may also be a newly defined MAC control element (MAC CE).

According to an embodiment, the thirty-first message may at least include one or more of the following information:
information indicating whether the fifth node can currently serve as an anchor UE;
information indicating that the fifth node can currently serve as an anchor UE;
information indicating that the fifth node cannot currently serve as an anchor UE;
information indicating a remaining time for which the fifth node can also serve as an anchor UE; or
information indicating a remaining time for which the fifth node can serve as an anchor UE again.

Continuing to refer to FIG. 9, after receiving the thirty-first message, according to content in the thirty-first message, the third node transmits the thirty-second message to the second node in step S920 for notifying the second node of the status of the anchor UE or releasing a configuration of a sidelink positioning reference signal. For example, the thirty-second message may be an existing NRPPa Positioning Information Update message, or other existing NRPPa messages or new NRPPa messages.

In some implementations, the thirty-second message may at least include one or more of the following information:
information indicating whether the fifth node can currently serve as an anchor UE;
information indicating that the fifth node can currently serve as an anchor UE;
information indicating that the fifth node cannot currently serve as an anchor UE;
information indicating a remaining time for which the fifth node can also serve as an anchor UE; or
information indicating a remaining time for which the fifth node can serve as an anchor UE again.
information for releasing the configuration of the sidelink positioning reference signal of the fifth node; or
identification information of the fifth node.

For example, the identification information of the fifth node included in the thirty-second message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

Continuing to refer to FIG. 9, in step S930, the fifth node transmits a thirty-third message to the second node, for indicating an anchor status that the fifth node serves as an anchor UE to the second node. For example, the thirty-third message may be an existing LPP Provide Capability message, or may also be other existing LPP messages or a new LPP message.

In some implementations, the thirty-third message may at least include one or more of the following information:
information indicating whether the fifth node can currently serve as an anchor UE;
information indicating that the fifth node can currently serve as an anchor UE;
information indicating that the fifth node cannot currently serve as an anchor UE;
information indicating a remaining time for which the fifth node can also serve as an anchor UE; or
information indicating a remaining time for the fifth node can serve as an anchor UE again.

Continuing to refer to FIG. 9, after receiving the thirty-second message or the thirty-third message, the second node transmits a thirty-fourth message to the first node in step S940, for indicating the anchor status that the fifth node serves as an anchor UE to the first node. For example, the thirty-third message may be an existing LPP Provide Assistance Data message, or may also be other existing LPP messages or a new LPP message.

In some implementations, the thirty-fourth message may at least include one or more of the following information:
information indicating whether the fifth node can currently serve as an anchor UE;
information indicating that the fifth node can currently serve as an anchor UE;
information indicating that the fifth node cannot currently serve as an anchor UE;
information indicating a remaining time for which the fifth node can also serve as an anchor UE; or
information indicating a remaining time for the fifth node can serve as an anchor UE again.
identification information of the fifth node.

For example, the identification information of the fifth node included in the thirty-fourth message may at least include one or more of the following information:
a ProSe application code/ProSe application code prefix (ProSe App Code/ProSe App Code Prefix);
a ProSe restricted code/ProSe restricted code prefix;
a ProSe response code/ProSe query code;
a source/destination layer-2 ID;
a source/destination layer-2 ID for direct discovery;
a source/destination layer-2 ID for direct communication;
a source/destination layer-2 ID for relay discovery;
a source/destination layer-2 ID for relay communication;
a relay service code;
other new ProSe identities; or
other new sidelink positioning identities.

The methods of anchor UE status updating/modification according to the embodiments of the disclosure have been described above. Through the methods, the target UE can know the anchor status of the anchor UE, thereby facilitating sidelink positioning.

Various embodiments of the disclosure have been described with reference to FIGS. 4A to 9. It should be noted that although various embodiments are described separately, those skilled in the art should understand that one or more of these embodiments can be combined to form new embodiments as needed, and the new embodiments formed should also belong to a part of the disclosure.

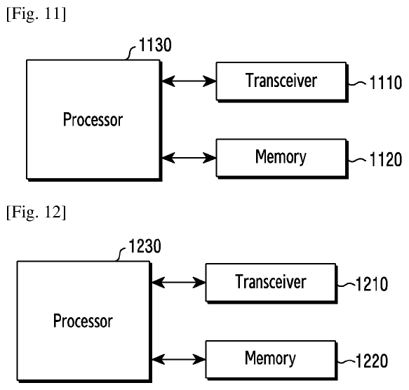

FIG. 10 illustrates a block diagram of a configuration of a node according to some embodiments of the disclosure. For example, the node may be implemented as any one of the first to sixth nodes described above.

Referring to FIG. 10, a node 1000 according to an embodiment of the disclosure may include a transceiver 1010, at least one processor 1020 and a memory 1030. The node may be implemented to include a greater or lesser number of elements than those shown in FIG. 10.

The transceiver 1010 may transmit signals to and receive signals from another node and/or network entity.

The processor 1020 may control the overall operation of the node. For example, the processor 1020 may control the transceiver 1010 and the memory 1030, so as to implement the methods for sidelink positioning described according to various embodiments of the disclosure.

The memory 1030 may store information, data, programs, instructions, etc., processed by the UE.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or status machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above descriptions are only exemplary implementations of the present invention, and are not intended to limit the protection scope of the present invention, which is determined by the appended claims.

A method performed by a first node in a wireless communication system is provided. The method comprises receiving information related to one or more user equipments (UEs), based on information related to at least one UE of the one or more UEs among the information related to the one or more UEs, transmitting, to a second node, a first request message for requesting the third node to configure a sidelink positioning reference signal (SL-PRS), receiving, from the second node, a first response message as a response of the first request message, the first response message including configuration information for the SL-PRS and transmitting the configuration information for the SL-PRS.

The information related to the one or more UEs includes at least UE identities (IDs) of the one or more UEs.

The first request message includes at least one of a UE ID or transmission characteristics of the SL-PRS.

The method further comprises transmitting, to the second node, a second request message for requesting activation or deactivation of transmission of a least one SLPRS and receiving, from the second node, a second response message for activation or deactivation of the transmission of the at least one SL-PRS, the second response message being a response of the second request message.

A first node in a wireless communication system is provided. The first node comprises a transceiver and a controller coupled with the transceiver and configured to receive information related to one or more user equipments (UEs), based on information related to at least one UE of the one or more UEs among the information related to the one or more UEs, transmit, to a second node, a first request message for requesting the third node to configure a sidelink positioning reference signal (SL-PRS), receive, from the second node, a first response message as a response of the first request message, the first response message including configuration information for the SL-PRS and transmit the configuration information for the SL-PRS.

The information related to the one or more UEs includes at least UE identities (IDs) of the one or more UEs.

The first request message includes at least one of a UE ID or transmission characteristics of the SL-PRS.

The controller is further configured to transmit, to the second node, a second request message for requesting activation or deactivation of transmission of a least one SLPRS and receive, from the second node, a second response message for activation or deactivation of the transmission of the at least one SL-PRS, the second response message being a response of the second request message.

A method performed by a second node in a wireless communication system is provided. The method comprises transmitting, to first node, information related to one or more user equipments (UEs), receiving, from the first node, a first request message for requesting configuring a sidelink positioning reference signal (SL-PRS), transmitting, to the first node, a first response message as a response of the first request message, the first response message including configuration information for the SLPRS.

The information related to the one or more UEs includes at least UE identities (IDs) of the one or more UEs.

The first request message includes at least one of a UE ID or transmission characteristics of the SL-PRS.

The method further comprises receiving, from the first node, a second request message for requesting activation or deactivation of transmission of a least one SLPRS and transmitting, to the first node, a second response message for activation or deactivation of the transmission of the at least one SL-PRS, the second response message being a response of the second request message.

A second node in a wireless communication system is provided. The second node comprises a transceiver and a controller coupled with the transceiver and configured to transmit, to first node, information related to one or more user equipments (UEs), receive, from the first node, a first request message for requesting configuring a sidelink positioning reference signal (SL-PRS), and transmit, to the first node, a first response message as a response of the first request message, the first response message including configuration information for the SL-PRS.

The information related to the one or more UEs includes at least UE identities (IDs) of the one or more UEs, and the first request message includes at least one of a UE ID or transmission characteristics of the SL-PRS.

The controller is further configured to receive, from the first node, a second request message for requesting activation or deactivation of transmission of a least one SLPRS and transmit, to the first node, a second response message for activation or deactivation of the transmission of the at least one SL-PRS, the second response message being a response of the second request message.

FIG. 11 illustrates a structure of a UE according to an embodiment of the disclosure.

As shown in FIG. 11, the UE according to an embodiment may include a transceiver 1110, a memory 1120, and a processor 1130. The transceiver 1110, the memory 1120, and the processor 1130 of the UE may operate according to a communication method of the UE described above. However, the components of the UE are not limited thereto. For example, the UE may include more or fewer components than those described above. In addition, the processor 1130, the transceiver 1110, and the memory 1120 may be implemented as a single chip. Also, the processor 1130 may include at least one processor. Furthermore, the UE of FIG. 11 corresponds to the UE 101 of the FIG. 1, respectively.

The transceiver 1110 collectively refers to a UE receiver and a UE transmitter, and may transmit/receive a signal to/from a base station or a network entity. The signal transmitted or received to or from the base station or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the UE. Also, the memory 1120 may store control information or data included in a signal obtained by the UE. The memory 1120 may be a storage medium, such as read-only memory (ROM), random access memory (RAM), a hard disk, a CD-ROM, and a DVD, or a combination of storage media.

The processor 1130 may control a series of processes such that the UE operates as described above. For example, the transceiver 1110 may receive a data signal including a control signal transmitted by the base station or the network entity, and the processor 1130 may determine a result of receiving the control signal and the data signal transmitted by the base station or the network entity.

FIG. 12 illustrates a structure of a base station according to an embodiment of the disclosure.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor. Furthermore, the base station of FIG. 12 corresponds to base station (e.g., NG-RAN 202 of FIG. 2, or E-UTRAN 102 of FIG. 1).

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CDROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

1-15. (canceled)

16. A method performed by a first user equipment (UE) in a wireless communication system, the method comprising:
transmitting, to a second UE, a discovery message for sidelink (SL) positioning, the discovery message including information for indicating whether the first UE supports an anchor UE for the SL positioning; and
in case that the first UE supports the anchor UE for the SL positioning, performing an SL positioning reference signal (PRS) measurement with the second UE.

17. The method of claim 16, wherein the discovery message includes at least one of information on an identity (ID) of the first UE, or information on an ID of the second UE.

18. The method of claim 16, wherein the second UE supports a target UE for the SL positioning.

19. The method of claim 16, further comprising:
receiving, from a location management function (LMF) entity, a request message for capability information of the first UE; and
transmitting, to the LMF entity, a response message including the information for indicating whether the first UE supports the anchor UE for the SL positioning.

20. A method performed by a second user equipment (UE) in a wireless communication system, the method comprising:
receiving, from a first UE, a discovery message for sidelink (SL) positioning, the discovery message including information for indicating whether the first UE supports an anchor UE for the SL positioning; and
in case that the first UE supports the anchor UE for the SL positioning, performing an SL positioning reference signal (PRS) measurement with the first UE.

21. The method of claim 20, wherein the discovery message includes at least one of information on an identity (ID) of the first UE, or information on an ID of the second UE.

22. The method of claim 20, wherein the second UE supports a target UE for the SL positioning.

23. The method of claim 20, further comprising:
receiving, from a location management function (LMF) entity, a request message for capability information of the second UE; and
transmitting, to the LMF entity, a response message including information for indicating whether the second UE supports an anchor UE for the SL positioning.

24. A first user equipment (UE) in a wireless communication system, the first UE comprising:
a transceiver; and
a controller coupled with the transceiver and configured to:
transmit, to a second UE, a discovery message for sidelink (SL) positioning, the discovery message including information for indicating whether the first UE supports an anchor UE for the SL positioning, and
in case that the first UE supports the anchor UE for the SL positioning, perform an SL positioning reference signal (PRS) measurement with the second UE.

25. The first UE of claim 24, wherein the discovery message includes at least one of information on an identity (ID) of the first UE, or information on an ID of the second UE.

26. The first UE of claim 24, wherein the second UE supports a target UE for the SL positioning.

27. The first UE of claim 24, wherein the controller is further configured to:
receive, from a location management function (LMF) entity, a request message for capability information of the first UE, and
transmit, to the LMF entity, a response message including the information for indicating whether the first UE supports the anchor UE for the SL positioning.

28. A second user equipment (UE) in a wireless communication system, the second UE comprising:
a transceiver; and
a controller coupled with the transceiver and configured to:
receive, from a first UE, a discovery message for sidelink (SL) positioning, the discovery message including information for indicating whether the first UE supports an anchor UE for the SL positioning, and
in case that the first UE supports the anchor UE for the SL positioning, perform an SL positioning reference signal (PRS) measurement with the first UE.

29. The second UE of claim 28, wherein the discovery message includes at least one of information on an identity (ID) of the first UE, or information on an ID of the second UE.

30. The second UE of claim 28, wherein the second UE supports a target UE for the SL positioning.
